(19) United States
(12) Patent Application Publication
(10) Pub. No.: US 2011/0238721 A1
(43) Pub. Date: Sep. 29, 2011

(54) ADDER CIRCUIT AND XIU-ACCUMULATOR CIRCUIT USING THE SAME

(75) Inventor: Liming XIU, Plano, TX (US)

(73) Assignee: NOVATEK MICROELECTRONICS CORP., HsinChu (TW)

(21) Appl. No.: 12/892,516

(22) Filed: Sep. 28, 2010

(30) Foreign Application Priority Data
Mar. 26, 2010 (TW) 099109254

(51) Int. Cl. G06F 7/50

(52) U.S. Cl. 708/670

(57) ABSTRACT

A Xiu-accumulator circuit including N cascaded adders is provided. Each adder includes two registers, wherein one register stores an addition result information and the other register stores a carry-in information. Respective addition result information from respective adder is further fed back to itself for accumulation. The carry-in information outputted from a previous stage adder is fed to a next stage adder at a next clock cycle. After N clock cycles, the carry-in information outputted from the first stage adder is fed to the last stage adder.

This application claims the benefit of Taiwan application Serial No. 99109254, filed Mar. 26, 2010, the subject matter of which is incorporated herein by reference.

### BACKGROUND OF THE INVENTION

1. Field of the Invention

The invention relates in general to an adder circuit and a Xiu-accumulator circuit using the same.

2. Description of the Related Art

Average computing is widely used in digital signal processing and other applications. Currently, averaging can be achieved through accumulation. Accumulation computing normally includes integer accumulation and non-integer (such as decimal or fraction) accumulation. In general, accumulation can be done by an adder.

FIG. 1A (prior art) shows a schematic diagram of integer accumulation. FIG. 1B (prior art) shows a schematic diagram of fraction accumulation. In FIG. 1A, the adder 100 is used for accumulation, wherein X denotes an initial value (X sometimes could be an unknown number) and I denotes an integer. After n clocks, the total accumulation is n*I, wherein n is a positive integer. Thus, after n clocks, the average increment is n*I/n=I. As indicated in FIG. 1B, I denotes an integer portion and r denotes a decimal portion. During accumulation, both the integer portion and the decimal portion will be accumulated. If the accumulation result of the decimal portion overflows, then a carry-in signal will be generated, and this carry-in signal will be propagated to the integer portion. Let FIG. 1B be taken for example. After n clocks, the total accumulation is n*I+n*r. At each clock, the increment could be I (when no carry-in occurs) or I+1 (when carry-in occurs). Here, after n clocks, the average increment is (n*I+n*r)/n=I+r. I and I+r are also referred as variables.

FIG. 2 (prior art) shows a schematic diagram of prior (n+1)-bit adder 200. The adder 200 adds up an (n+1)-bit augend A and an (n+1)-bit addend B to obtain an addition result S. As indicated in FIG. 2, the (n+1)-bit adder 200 includes a plurality of 1-bit full adders 210 and a plurality of registers 220. The inputs of respective 1-bit full adder 210 are A, B and Cl; and the outputs of respective 1-bit full adder 210 are S and CO. All 1-bit full adders are serially connected to form the adder 200. The output CO of a previous stage full adder is fed to the input CI of a next stage full adder. Only when all carry-in signals CI are propagated to the last stage of the full adder will the addition computing be regarded as completed. The addition result of respective full adder will be stored in the registers 220 controlled by the clock signal CLK.

FIG. 3 (prior art) shows a schematic diagram of a prior accumulator 300. As indicated in FIG. 3, the output of respective 1-bit full adder will be fed back to its input for accumulation at the next clock cycle. AₙAₙ₋₁Aₙ₋₂ . . . A₀.A₋₁ . . . A₋ₘ stored in the register is the addition result obtained at the current clock cycle. One of the features of the accumulator is that both the input and the addition result of the accumulator are real numbers. The integer portion of the accumulation result is AₙAₙ₋₁Aₙ₋₂ . . . A₀, the decimal portion is A₋₁ . . . A₋ₘ, and the two portions are separated by a decimal point DP.

As the bit number grows (I or (I+r) having more bit number), the computing speed of the adder becomes slower, circuit area as well as power consumption will increase significantly. For some specific applications, in order to achieve average computing, the decimal portion can even have 64 bits. It is very expensive for such a huge adder to achieve GHz-order computing speed, and the cost (involving circuit area and power consumption) is very high. In general, only in very high performance and large volume designs (such as a general purpose CPU), such a large size adder can be afforded.

As the bit number of the processor bus grows and the processor speed increases, the design of the adder (which could be the core of complicated computing circuits) becomes very difficult. Therefore, an adder and an accumulator which resolve the shortcomings encountered in prior art are greatly needed.

### SUMMARY OF THE INVENTION

Embodiments of the invention are directed to an adder circuit and a Xiu-accumulator circuit using the same. The carry-in information of a previous stage adder is not propagated to a next stage adder until the next clock cycle. Despite the fact that the addition result is not necessarily correct at each clock cycle, the number of carry-in occurrences is always correct.

An adder circuit is provided according to an embodiment of the invention. The adder circuit includes a first adder. The first adder includes a first addition unit, a first register coupled to the first addition unit and a second register coupled to the first addition unit. At a first clock cycle, the first addition unit adds up an augend signal, an addend signal and a first signal to generate a first addition result signal and a first carry-in signal. The first register stores the first addition result signal and the second register stores the first carry-in signal.

An adder circuit including N cascaded adders is provided according to another embodiment of the invention. Each of the N cascaded adders includes a first register and a second register, wherein the first registers store an addition result information, and the second registers store a carry-in information. The carry-in information outputted from a previous stage adder is fed to a next stage adder at a next clock cycle, and after N clock cycles, the carry-in information outputted from the first stage adder is fed to the last stage adder, N being a natural number.

An accumulator circuit including a first adder is provided according to yet another embodiment of the invention. The first adder includes a first addition unit, a first register coupled to the first addition unit, and a second register coupled to the first addition unit. At a first clock cycle, the first addition unit accumulates a variable and an output of the first register to generate a first addition result signal and a first carry-in signal. The first register stores the first addition result signal and the second register stores the first carry-in signal.

An accumulator circuit including N cascaded adders is provided in still yet another embodiment of the invention. Each adder includes two registers, wherein one register stores an addition result information, and the other register stores a carry-in information. Respective addition result information from respective adder is further fed back to itself for accumulation. The carry-in information outputted from a previous stage adder is fed to a next stage adder at a next clock cycle. After N clock cycles, the carry-in information outputted from the first stage adder is fed to the last stage adder.

The invention will become apparent from the following detailed description of the preferred but non-limiting embodiments. The following description is made with reference to the accompanying drawings.

### BRIEF DESCRIPTION OF THE DRAWINGS

FIG. 1A shows a schematic diagram of integer accumulation;

FIG. 1B shows a schematic diagram of fraction accumulation;

FIG. 2 shows a schematic diagram of a prior (n+1)-bit adder;

FIG. 3 shows a schematic diagram of a prior accumulator;

FIG. 4A shows a 1-bit Xiu-accumulator according to an embodiment of the invention;

FIG. 4B shows a multi-bit Xiu-accumulator according to the embodiment of the invention;

FIG. 4C shows a schematic diagram of a prior 1-bit accumulator;

FIG. 4D shows a schematic diagram of a prior multi-bit accumulator;

FIG. 5 shows a schematic diagram of a prior 6-bit adder;

FIG. 6 shows a 6-bit adder according to another embodiment of the invention;

FIG. 7A shows an addition result (r=0.000001b) according to the embodiment of the invention;

FIG. 7B shows the timing in generating carry-in bits (r=0.000001b) according to the embodiment of the invention;

FIG. 7C shows an addition result (r=0.000001b) according to the prior art; and

FIG. 7D shows the timing in generating carry-in bits (r=0.000001b) according to the prior art.

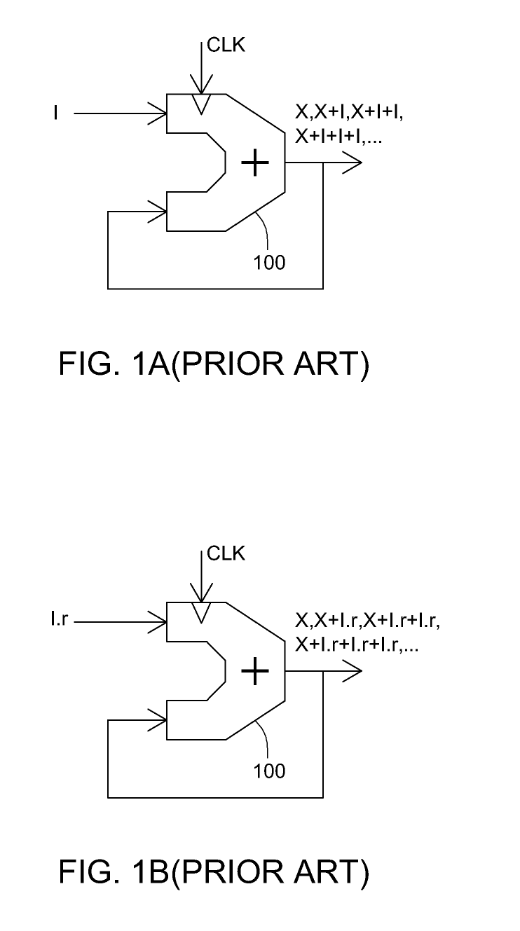

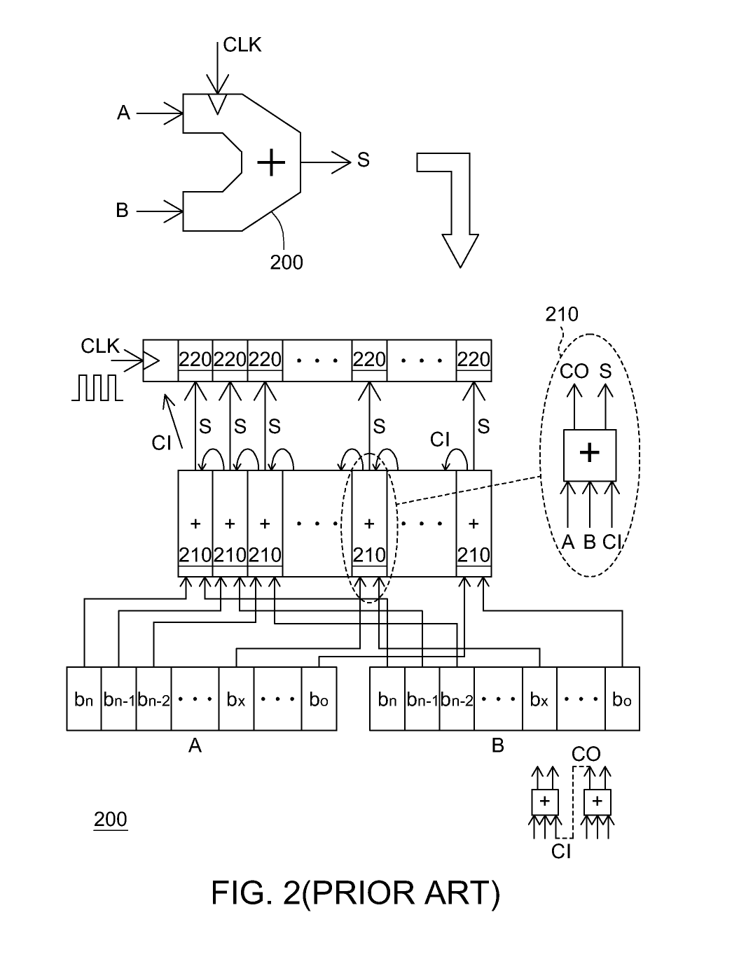

### DETAILED DESCRIPTION OF THE INVENTION

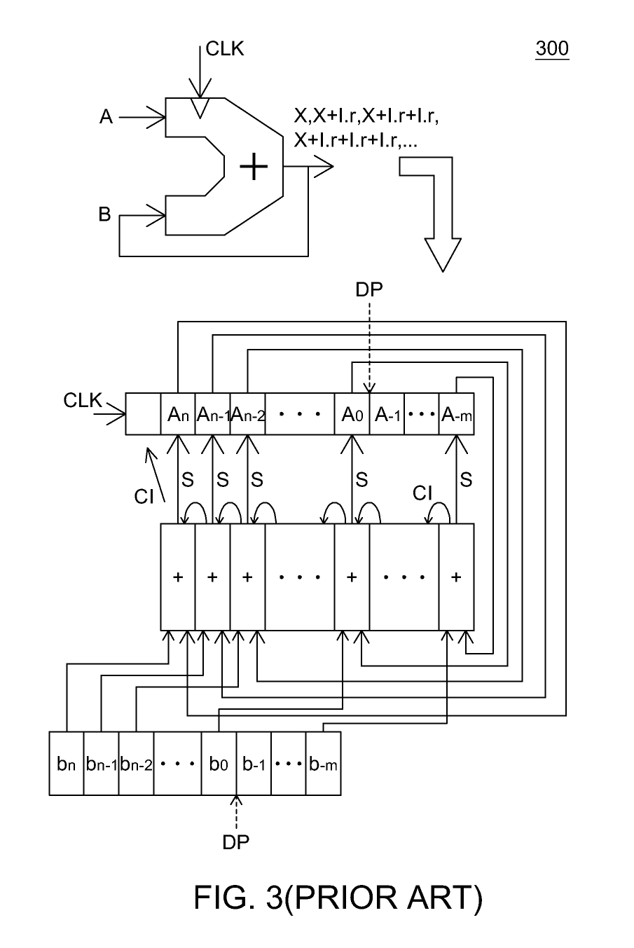

Referring to FIG. 3. In circuit operation (such as average computing), normally only the integer portion of the addition result will be used, and the decimal portion of the addition result is only used for accumulation. Only when overflowing occurs will the carry-in of the decimal portion of the addition result affects circuit operation. Therefore, in practical operation, (1) the integer portion of the addition result and (2) the carry-in of the accumulation of the decimal portion will carry useful information. At any moment, the decimal portion of the addition result does not affect the correctness in computing of this average. That is, at any moment, whether the decimal portion of the addition result is correct or not does not matter because the correctness in the computing of the average is not affected. The averaging result will be correct as long as the number of the occurrences of carry-in within a predetermined time window is correct regardless whether the accumulation result of the decimal portion is correct or not.

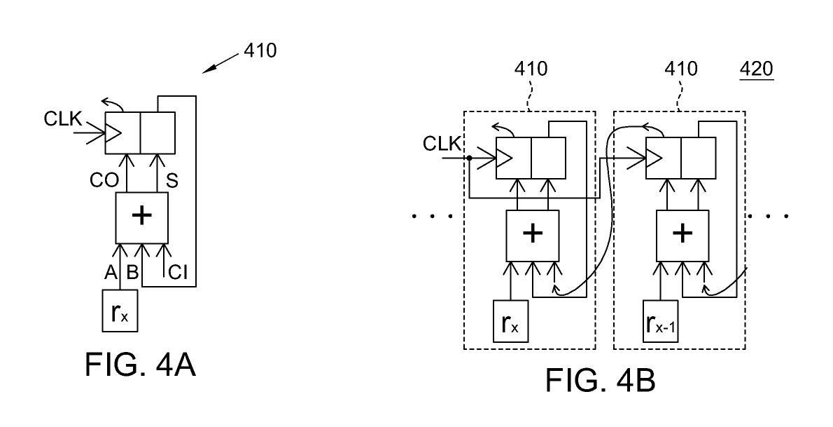

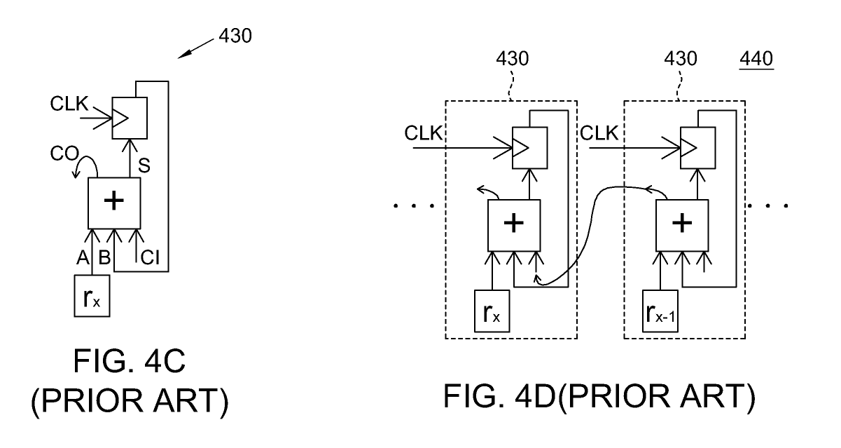

Thus, a new adder and a Xiu-accumulator using the same are provided according to an embodiment of the invention. FIG. 4A shows a 1-bit Xiu-accumulator 410 according to the embodiment of the invention. FIG. 4B shows a multi-bit Xiu-accumulator 420 according to the embodiment of the invention, wherein the multi-bit Xiu-accumulator 420 is formed by a plurality of 1-bit Xiu-accumulators 410. As indicated in FIG. 4A and FIG. 4B, the addition result S and the carry-in result CO are stored to the register, and the carry-in result of a previous stage are fed to a next stage at next clock cycle, so the computing speed is increased significantly. Furthermore, let the multi-bit accumulator be a 4-bit accumulator formed by 4 cascaded 1-bit full adders. After 4 clock cycles, the carry-in bits generated from the first stage (the initial) 1-bit full adder will be fed to the fourth stage (the last) 1-bit full adder. In the embodiment of the invention, the clock can have high frequency, hence speeding the overall operation.

FIG. 4C shows a schematic diagram of a prior 1-bit accumulator 430. FIG. 4D shows a schematic diagram of a prior multi-bit accumulator 440 including many 1-bit accumulators 430. In the prior art, the carry-in result from each 1-bit adder must be sequentially propagated forward at each clock cycle until all carry-in results are fed to the last stage, so as to finish the addition/accumulation. To avoid computing errors, the clock shall not have high frequency. Consequently, the computing speed is restricted.

Mathematical Proof:

In the embodiment of the invention, within a period of time, firstly, the number of the occurrence of the carry-in caused by the decimal portion of the accumulation result is useful (the decimal portion itself is not important); secondly, the timing of the occurrence of carry-in does not affect the long term result; thirdly, the sequence of the occurrence of carry-in does not affect the long term result either.

In the long term, the prior accumulator and the accumulator according to the embodiment of the invention generate the same number of carry-in bits.

Suppose r is a decimal number, wherein 0<r<1. Let the b-based m-bit system be taken for example, r can be expressed as follows:

r=r₁b⁻¹+r₂b⁻²+r₃b⁻³+ . . . rₘb^{-m} (1)

After b^{m} clock cycles, the accumulation result of the decimal portion can be expressed as follows:

S₁=b^{m}r=r₁b^{m-1}+r₂b^{m-2}+r₃b^{m-3}+ . . . rₘb (2)

As indicated in equation (2), after b^{m} clock cycles, all decimal portions will be propagated to the integer portion, and b^{m}r denotes the total number of carry-in generated during the b^{m} clock cycles.

Besides, r can further be expressed as follows:

$$r = {r}_{1} {b}^{- 1} + 0 {b}^{- 2} + 0 {b}^{- 3} + … 0 {b}^{- m} + {0}_{1} {b}^{- 1} + {r}_{2} {b}^{- 2} + 0 {b}^{- 3} + … 0 {b}^{- m} + {0}_{1} {b}^{- 1} + 0 {b}^{- 2} + {r}_{3} {b}^{- 3} + … 0 {b}^{- m} + … + {0}_{1} {b}^{- 1} + 0 {b}^{- 2} + 0 {b}^{- 3} + … {r}_{m} {b}^{- m} \qquad ( 3 )$$

Some designations in equation (3) are defined as follows:

$${R}_{1} ≡ {r}_{1} {b}^{- 1} \\ {R}_{2} ≡ {r}_{2} {b}^{- 2} \\ {R}_{3} ≡ {r}_{3} {b}^{- 3} \\ … \\ {R}_{m} ≡ {r}_{m} {b}^{- m} \qquad ( 4 )$$

The accumulation of R₁˜Rₘ can be performed by the accumulator of FIG. 4A. Thus, after b^{m} clock cycles, the accumulation result can be expressed as follows:

$${b}^{m *} {R}_{1} ≡ {r}_{1} {b}^{m - 1} \\ {b}^{m *} {R}_{2} ≡ {r}_{2} {b}^{m - 2} \\ {b}^{m *} {R}_{3} ≡ {r}_{3} {b}^{m - 3} \\ … \\ {b}^{m *} {R}_{m} ≡ {r}_{m} b \qquad ( 5 )$$

Since the m 1-bit full adders are serially connected (as indicated in FIG. 4B), the carry-in bits generated by each stage will be gradually propagated forward at each clock cycle. The generated carry-in bits will not be lost. Therefore, after b^{m} clock cycles, the accumulation result of the decimal portion can be expressed as follows:

$$\begin{matrix}{S}_{2} = {b}^{m *} R 1 + {b}^{m *} R 2 + {b}^{m *} R 3 + … {b}^{m *} Rm \\ = {r}_{1} {b}^{m - 1} + {r}_{2} {b}^{m - 2} + {r}_{3} {b}^{m - 3} + … {r}_{m} b \\ = {S}_{1}\end{matrix} \qquad ( 6 )$$

As indicated in equation (6), after b^{m} clock cycles, the accumulation result of the decimal portion generated according to the prior art and the accumulation result of the decimal portion generated according to the embodiment of the invention are the same.

Simulation:

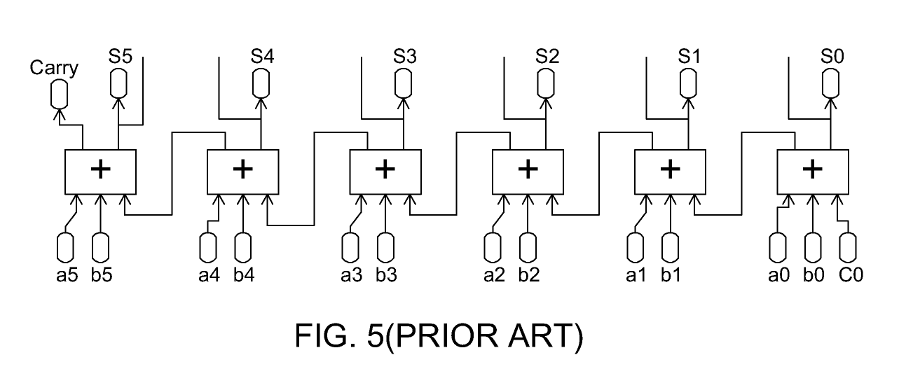

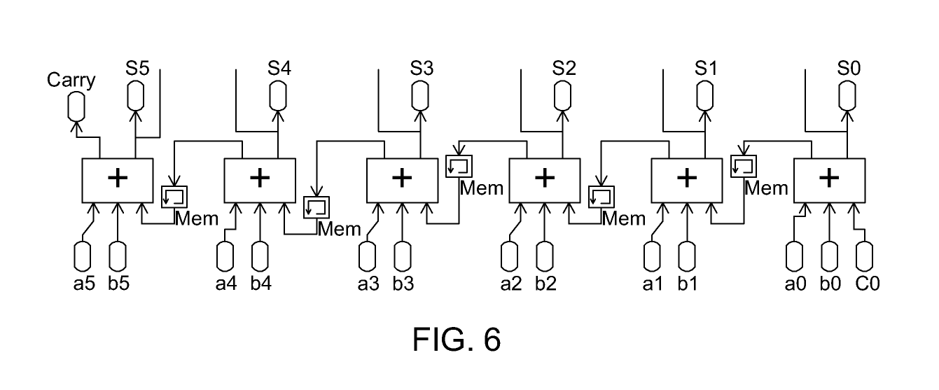

FIG. 5 (prior art) shows a schematic diagram of a prior 6-bit adder. FIG. 6 shows a 6-bit adder according to the embodiment of the invention. In FIG. 5 and FIG. 6, the designations S0˜S5 denote addition results, the designations a0˜a5 and b0˜b5 denote addends and augends, and the designation Carry denotes carry-in.

As indicated in FIG. 6, a memory unit Mem is disposed between the output CO of a previous stage and the input Cl of a next stage, wherein the memory unit is similar to the register of FIGS. 4A and 4B. The adder can achieve the function of an accumulator if the output S of the adder is connected to the input b of the adder itself.

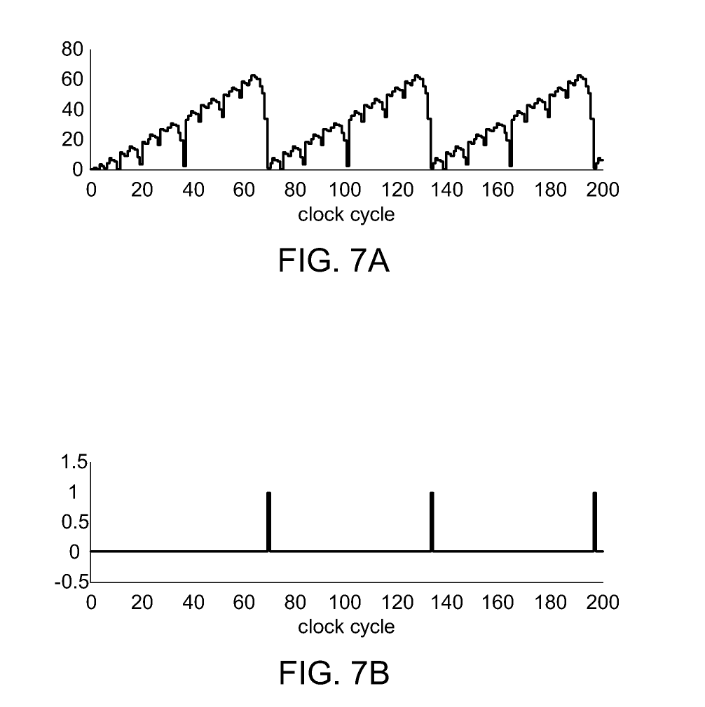

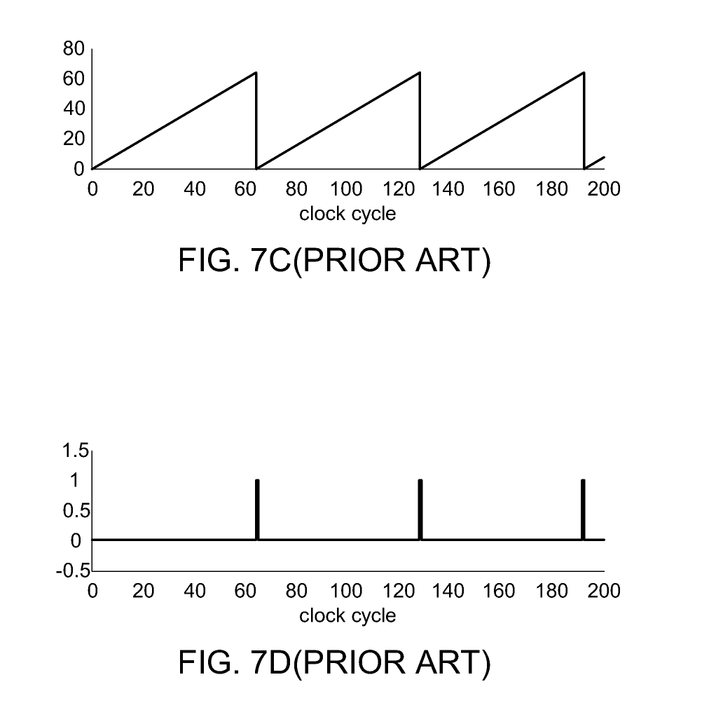

FIGS. 7A-7D simulate the situation when r=0.000001b. FIG. 7A shows an addition result (r=0.000001b) according to the embodiment of the invention. FIG. 7B shows the timing of generation of carry-in (r=0.000001b) according to the embodiment of the invention. FIG. 7C shows an addition result (r=0.000001b) according to the prior art. FIG. 7D shows the timing of generation of carry-in (r=0.000001 b) according to the prior art.

As indicated in FIG. 7C and FIG. 7D, the addition result obtained according to the prior art is linearly increased. Moreover, a carry-in bit will be generated after every 64 cycles (b=2 and m=6 in equation (1) and r=0.000001b). For each clock cycle, the addition result obtained according to the embodiment of the invention could be different from that obtained according to the prior art. For most of the clock cycles, the addition result obtained according to the embodiment of the invention may not be correct. A comparison between FIG. 7B and FIG. 7D shows that despite the timing of generation of carry-in according to the embodiment of the invention is different from that according to the prior art, after every 64 clocks (b^{m}=2⁶=64), both the embodiment of the invention and the prior art will generate 1 carry-in. That is, within any 64 clock cycles, the number of carry-in bits generated according to the embodiment of the invention and that generated according to the prior art are the same. As disclosed above, during the process of average computing, the number of carry-in of the decimal portion affects the result of average computing, and whether the computing result of the decimal portion is correct or not does not affect the result of average computing. Therefore, the result of average computing obtained according to the embodiment of the invention and that obtained according to the prior art are the same in the long term. That is, in the long term, the result of average computing obtained according to the embodiment of the invention is correct.

The adder and the Xiu-accumulator using the same disclosed in the above embodiments of the invention have many advantages exemplified below:

(1) Speed Advantage:

Table 1 shows a comparison of computing time (i.e. computing speed) between the prior art and the embodiment of the invention. In the prior art, the computing speed is significantly and negatively affected by the increase in the bit number of the adder. In other words, during the process of accumulation, as the bit number of the decimal portion grows, the computing speed according to the prior art significantly slows down. As for the embodiment of the invention, even in the cases of the bit number of the decimal portion in accumulation grows significantly, the speed of the accumulator still can be regarded as the same as the speed of a 1-bit full adder. In other words, in the embodiment of the invention, the speed of the accumulator is determined by the bit number of the integer portion of the adder. This is because in the embodiment of the invention, the computing result of the decimal portion is not important and what really matters is the number of carry-in bits of the decimal portion. In general, during the process of accumulation, the bit number of the integer portion is smaller than that of the decimal portion. In Table 1, the integer portion is fixed as 3 bits. As indicated in Table 1, as the bit number of the decimal portion grows, the computing time according to the prior art becomes significantly longer, but the computing time according to the embodiment of the invention is almost not affected by the increase in the bit number of the decimal portion.

TABLE 1

| Bit Number | prior art (ns) | Embodiment Of The Invention (ns) |
|---|---|---|
| 24 bits | 0.61 | 0.43 |
| 32 bits | 0.63 | 0.43 |
| 48 bits | 0.72 | 0.43 |
| 64 bits | 0.72 | 0.43 |

(2) Comparison of Circuit Area:

Table 2 shows a comparison of circuit area between the prior art and the embodiment of the invention. As indicated in Table 2, as the bit number increases, the circuit area of the prior art becomes significantly larger, but the increase in the circuit area according to the embodiment of the invention is not as large.

TABLE 2

| Bit Number | prior art | Embodiment Of The Invention |
|---|---|---|
| 24 bits | 622.75 (516, 106.75) | 315.5 (135.5, 180) |
| 32 bits | 887.75 (743.75, 144) | 417.5 (173.5, 244) |
| 48 bits | 1295.5 (1085.5, 210) | 621.5 (249.5, 372) |
| 64 bits | 1914.5 (1627.5, 287) | 825.5 (325.5, 500) |

In Table 2, the circuit area is in unit of NAND logic gates. For example, when the adder is a 24-bit adder, the Xiu-accumulator (such as the structure of FIG. 4B) according to the embodiment of the invention has 315.5 NAND logic gates, wherein, the combinational logic gate count is 135.5 NAND logic gates and the sequential logic gate count is 180 NAND logic gates.

As indicated in Table 2, the 1-bit full adder according to the prior art only requires 1 register (for storing an addition result S), but the 1-bit full adder according to the embodiment of the invention requires 2 registers (for storing an addition result S and a carry bit CO). However, the circuit area according to the embodiment of the invention is far smaller than that according to the prior art.

(3) Comparison of Power Consumption:

Table 3 shows a comparison of power consumption between the prior art and the embodiment of the invention. As indicated in Table 3, as the bit number grows, the power consumption according to the prior art increases significantly, but the increase in power consumption according to the embodiment of the invention is smaller. As indicated in Table 3, the power consumption according to the embodiment of the invention is about a half of that according to the prior art.

TABLE 3

| | | | | Embodiment Of | | |
|---|---|---|---|---|---|---|
| | Prior art | | | The Invention | | |
| Bit | 1 | 500 | 100 | 1 | 500 | 100 |
| Number | GHz | MHz | MHz | GHz | MHz | MHz |
| 24 bits | 3.33 | 1.69 | 0.36 | 1.75 | 0.88 | 0.18 |
| 32 bits | 4.51 | 2.27 | 0.47 | 2.20 | 1.13 | 0.23 |
| 48 bits | 6.22 | 3.13 | 0.67 | 3.35 | 1.68 | 0.35 |
| 64 bits | 9.76 | 4.96 | 1.04 | 4.41 | 2.18 | 0.46 |

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An adder circuit, comprising:
a first adder, comprising:
a first addition unit;
a first register coupled to the first addition unit; and
a second register coupled to the first addition unit;
wherein, at a first clock cycle,
the first addition unit adds up an augend signal, an addend signal and a first signal to generate a first addition result signal and a first carry-in signal;
the first register stores the first addition result signal; and
the second register stores the first carry-in signal.

2. The adder circuit according to claim 1, further comprising:
a second adder coupled to the first adder, comprising:
a second addition unit coupled to the second register of the first adder;
a third register coupled to the second addition unit; and
a fourth register coupled to the second addition unit;
wherein, at a second clock cycle,
the first register outputs the first addition result signal;
the second register outputs the first carry-in signal to the second addition unit;
the second addition unit adds up the augend signal, the addend signal and the first carry-in signal to generate a second addition result signal and a second carry-in signal;
the third register stores the second addition result signal; and
the fourth register stores the second carry-in signal.

3. An adder circuit, comprising:
N cascaded adders each comprising a first register and a second register, wherein the first registers store an addition result information, and the second registers store a carry-in information;
wherein, the carry-in information outputted from a previous stage adder is fed to a next stage adder at a next clock cycle, and after N clock cycles, the carry-in information outputted from the first stage adder is fed to the last stage adder, N being a natural number.

4. An accumulator circuit, comprising:
a first adder, comprising:
a first addition unit;
a first register coupled to the first addition unit; and
a second register coupled to the first addition unit;
wherein, at a first clock cycle,
the first addition unit accumulates a variable and an output of the first register to generate a first addition result signal and a first carry-in signal;
the first register stores the first addition result signal; and
the second register stores the first carry-in signal.

5. The accumulator circuit according to claim 4, further comprising:
a second adder coupled to the first adder, wherein the second adder comprises:
a second addition unit coupled to the second register of the first adder;
a third register coupled to the second addition unit; and
a fourth register coupled to the second addition unit;
wherein, at a second clock cycle,
the first register outputs the first addition result signal;
the second register outputs the first carry-in signal to the second addition unit;
the second addition unit accumulates the variable and the first carry-in signal outputted from the second register to generate a second addition result signal and a second carry-in signal;
the third register stores the second addition result signal; and
the fourth register stores the second carry-in signal.

6. An accumulator circuit, comprising:
N cascaded adders each adder comprising a first register and a second register, wherein the first registers store an addition result information, the second registers store a carry-in information, and respective addition result information outputted from the respective adder is further fed back to itself for accumulation;
wherein, the carry-in information outputted from a previous stage adder is fed to a next stage adder at a next clock cycle, and after N clock cycles, the carry-in information outputted from a first stage adder is fed to a last stage adder.
